(19) United States
(12) Patent Application Publication
(10) Pub. No.: US 2004/0103780 A1
(43) Pub. Date: Jun. 3, 2004

(54) Hydropneumatic hybrid cylinder with tandem pistons and dampening hydraulic chambers disposed between them

(76) Inventor: Mark Y. Shteynberg, Lynnwood, WA (US)

Correspondence Address: Mark Y. Shteynberg, P.O. Box # 356, Lynnwood, WA, 98046-0356, US

(21) Appl. No.: 10/307,549

(22) Filed: Dec. 2, 2002

(51) Int. Cl. F15B 21/04

(52) U.S. Cl. 92/82

(57) ABSTRACT

A hydropneumatic hybrid cylinder with tandem pistons and dampening hydraulic chambers disposed between them for combining pneumatically powered actuation with incompressible and controllable hydraulic dampening in order to achieve smooth displacement, rapid stopping and steady and accurate positioning of the cylinder in which hydraulic damping of a pneumatic actuator is achieved through utilizing positive-displacement hydraulic actuator means with zero volumetric differential.

### BACKGROUND OF THE INVENTION

The present invention relates to improved hydro-pneumatic hybrid linear displacement devices generally named “hydropneumatic cylinders”. Devices of this type are designed to utilize the energy of compressed gas for powering linear motion, and using liquid for dampening and motion control. Hydropneumatic cylinders per the present invention have a broad spectrum of applications in many industrial fields, and can be used for actuating a variety of machine parts and objects. More particularly, this invention pertains to a new and improved structure for hydropneumatic cylinders with positive-displacement zero volumetric differential hydraulic dampening means, which allows modification-flexible, economical, and long lasting products.

It is known from U.S. Pat. No. 3,176,801 to Joseph F. Huff, et. al. combining a single rod pneumatic cylinder with a positive-displacement zero volumetric differential hydraulic dampening cylinder by forming them in a tandem-like structure. There exist two obvious disadvantages of such an arrangement: the use of two dynamic seals (o-rings or otherwise) to isolate the hydraulic chambers of the dampening cylinder from the external environment, and thus, to retain dampening fluid within the cylinder, and the use of external channels for dampening fluid to correspond between the hydraulic chambers. The first disadvantage is due to the known fact of notorious leakage of dynamic sealing engagements, which causes the loss of dampening fluid. The second disadvantage is due to the inconvenient geometry of the assembly and significant number of statically sealed but external joints, which decrease the reliability of the entire device.

It is also known from U.S. Pat. No. 6,481,335 to Mark Y. Shteynberg to position positive-displacement zero volumetric differential hydraulic dampening cylinders inside the piston-rod assembly of the pneumatic cylinder, however, these arrangements are either too expensive to produce, or they have significant working pressure limitations. In most instances, they have at least one dynamic seal between the hydraulic chambers of the dampening cylinder and the surrounding environment.

Regardless of the precise merits, features and advantages of the above cited references none of them achieves or fulfills the goal of providing modification flexible, economical, and long lasting technology combining the advantages separately inherent to pneumatic and positive-displacement hydraulic actuation.

### SUMMARY OF THE INVENTION

It is therefore, a principle object of the present invention to provide a hydropneumatic cylinder capable of smooth actuation, for which speed and positioning can be controlled with a high level of accuracy.

It is also an object of the present invention to provide an inexpensive, reliable, and long lasting hydropneumatic cylinder.

Yet another object of the present invention is to provide a hydropneumatic cylinder the general structure of which allows flexible and inexpensive modifications and customizations.

The present invention achieves the forgoing objectives by the use of a zero volumetric differential hydraulic dampening cylinder with tandem pistons mounted on the same rod serving simultaneously the functions of pneumatic and hydraulic actuation means, and having dampening hydraulic chambers disposed between them.

Such hydropneumatic cylinders are simple and inexpensive due to the small number of components from which they can be constructed. The majority of components can be generic. All hydraulic chambers are internal and all dynamic seals are positioned between the active pneumatic chambers and dampening hydraulic chambers in such a manner that generated pressure differentials between active pneumatic chambers and the adjacent dampening hydraulic chambers work against dampening fluid leakage.

Further objects and advantages of this invention will become apparent from the consideration of the drawings and ensuing description.

### BRIEF DESCRIPTION OF THE DRAWINGS

FIG. 1A shows a longitudinal sectional view of a hydropneumatic cylinder according to a first embodiment of the present invention, illustrating first type of fluid flow governor means.

FIG. 1B shows a similar partial enlarged sectional view of another embodiment of a hydropneumatic cylinder, illustrating second type of fluid flow governor means.

FIG. 1C shows a similar partial enlarged sectional view of yet another embodiment of a hydropneumatic cylinder, illustrating third type of fluid flow governor means.

FIG. 2A shows a longitudinal sectional view of a hydropneumatic cylinder according to a fourth embodiment of the present invention, illustrating a double-rod cylinder.

FIG. 2B shows a longitudinal sectional view of a hydropneumatic cylinder according to a fifth embodiment of the present invention, illustrating a hollow-rod cylinder.

FIG. 3A shows a longitudinal sectional view of a hydropneumatic cylinder according to a sixth embodiment of the present invention, illustrating a rodless cylinder.

FIG. 3B shows a longitudinal sectional view of a hydropneumatic cylinder according to a seventh embodiment of the present invention, illustrating a cable-rod cylinder.

FIG. 4 shows a longitudinal sectional view of a hydropneumatic cylinder according to a eighth embodiment of the present invention, illustrating a cylinder equipped with a linear displacement transducer.

### DETAILED DESCRIPTION OF THE PREFERED EMBODIMENTS

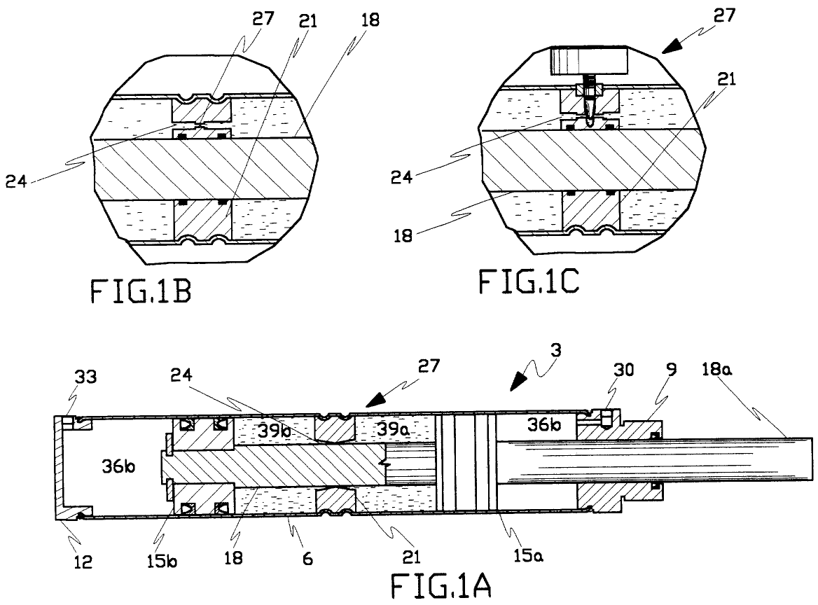

FIG. 1A shows a longitudinal sectional view of a hydropneumatic cylinder according to a first embodiment of the present invention.

The hydropneumatic cylinder per the first embodiment of the present invention generally comprises a housing unit 3, actuating means that further comprises two joined in tandem equal diameter pistons, a first piston 15a and a second piston 15b, with both pistons fixedly mounted on a constant diameter rod 18, a dividing member 21 installed stationary inside housing unit 3, a dampening fluid path 24, and a dampening fluid flow governor means 27.

The housing unit 3 is further comprised of a hollow cylindrical body 6, a front closure 9 fixedly mounted at the front end of the hollow cylindrical body 6, a rear closure 12 fixedly mounted at the rear end of the hollow cylindrical body 6.

The actuating means is coaxially and movably disposed inside the hollow cylindrical body 6, thus, dividing all volume inside the housing unit 3 into three chambers: chambers 36a and 36b, and a chamber in the middle of the housing unit 3, which is further composed of a chamber 39a and a chamber 39b formed by the dividing member 21 being positioned across the third chamber. The total volume of chambers, 39a and 39b, always remains constant, and is called “active volume of hydraulic cylinder”. The chambers 39a and 39b and all adjacent and communicating cavities are completely filled with dampening fluid and permanently sealed.

Chambers 36a and 36b are the two pneumatic chambers. Chamber 36a is adjacent to the front closure 9, and chamber 36b is adjacent to the rear closure 12.

The front closure 9 is formed with an air channel 30. The rear closure 12 is formed with an air channel 33. Through air channels 30 and 33 compressed air can be provided into the chambers 36a and 36b respectively, to power the actuating means.

The rod 18 axially extends through an axial bore formed in the dividing member 21 and, in combination with the dividing member 21, forms the dampening fluid path 24 and the dampening fluid flow governor means 27. The dampening fluid path 24 is formed as an annular tube between the wall surface of the bore through the dividing member 21 and the surface of the rod 18. The dampening fluid flow governor means 27 is formed as a narrowed annular orifice between the wall surface of the bore through the dividing member 21 and the surface of the rod 18.

Due to the rod 18 having a constant diameter and pistons 15a and 15b having equal diameters, the active volume of the hydraulic cylinder remains constant regardless of the position of the actuating means inside the housing unit 3. The design arrangement such as described provides conditions under which the volume of dampening fluid displaced from one of the chambers (39a or 39b) is always equal to the volume of dampening fluid received by the opposite chamber (39b or 39a) In the following such conditions will be referred to as “zero volumetric differential”. The conditions of “zero volumetric differential” can also be mathematically described by the following equation:

$$\frac{{V}_{39 a}}{{I}_{15 a}} = \frac{{V}_{39 b}}{{I}_{15 b}}$$

Where:

V₃₉ₐ—volumetric change of the first hydraulic chamber 39a;

I₁₅ₐ—linear displacement of the piston 15a;

V_{39b}—simultaneous volumetric change of the second hydraulic chamber 39b associated with the volumetric change V₃₉ₐ of the first hydraulic chamber 39a;

I_{15b}—linear displacement of the piston 15b associated with the linear displacement I₁₅ₐ of the piston 15a.

The fluid flow governor means 27 is schematically disposed in series with the dampening fluid path 24 in the way of the flow of dampening fluid corresponding between the chambers 39a and 39b to govern the flow rate of dampening fluid during operation.

When compressed air is let into the channel 30 and further to the chamber 36a it causes the piston 15a to move rearward. Respectively, when compressed air is let into the channel 33 and further to the chamber 36b it causes the piston 15b to move forward. An actuation of one of the pistons, 15a or 15b, results in the displacement of the entire actuation means including the dampening fluid disposed between pistons 15a and 15b. During such displacement the dampening fluid contained in the chambers 39a and 39b is being effectively redistributed between them, whereby hydraulic dampening takes place. For example, when the actuating means move forward the dampening fluid is being forced from the chamber 39b through the dampening fluid path 24 and the fluid flow governor means 27 into the chamber 39a.

The hydropneumatic cylinder, per the first embodiment of the present invention, also comprises attached to the front end of the actuation means a single rod 18a axially extending in sealing engagement through an axial bore formed in the front closure 9, whereby allowing to translate the motion generated by the actuation means into motion which can be utilized externally.

An example of a modified embodiment with a differently arranged permanent orifice serving the function of the governor means 27 is shown on FIG. 1B.

The governor means 27 shown on FIG. 1B is constructed as a permanent orifice in the form of a small diameter bore through the dividing member 21. This modification (except for it's geometry, manufacturing methods and some minor fluid flow characteristics of the used orifice) functionally presents no major differences in comparison with the permanent orifice of FIG. 1A.

Another modification of the first embodiment shown on FIG. 1C uses a different type of fluid control devices to serve the function of governor means 27 known as “needle valve”.

As opposed to permanent orifices, valve type devices, in general, are devices that govern the flow through restricting the flow rate by changing the cross-sectional area of the passing channel (instantaneously or gradually depending on their type and construction).

Naturally, the example of a “needle valve” utilized for the governor means 27 between hydraulic chambers in the embodiment modification shown on FIG. 1C, should not be construed as a limitation on the scope of this invention. In fact, in accordance with the present invention any type of valve or permanent orifice as well as their combinations can be used for the governor means 27 depending on the technical specifications of particular applications. Therefore, the forgoing shall be considered only as an illustration of the principles of the present invention, and, since numerous modifications will readily occur to those skilled in the art, it is not desired to limit this invention to the exact construction and operation shown and described.

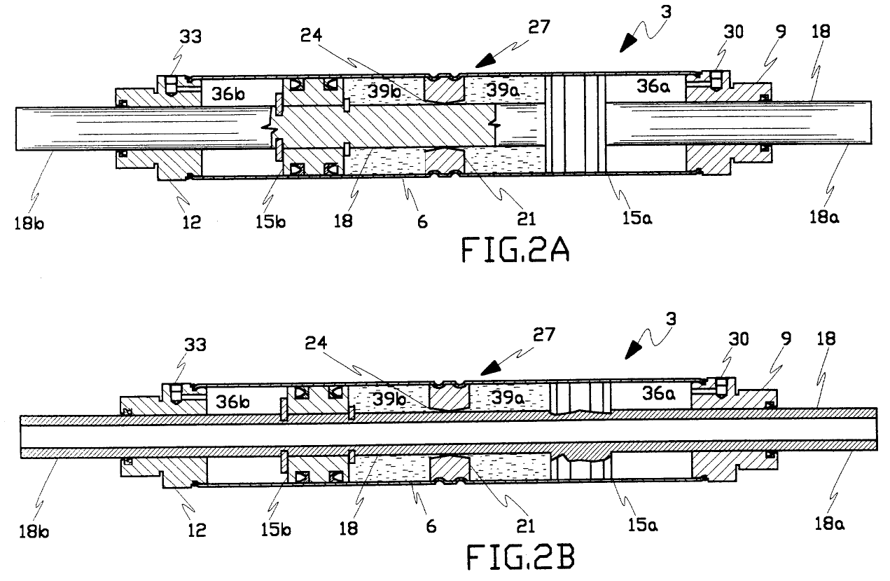

In the embodiment modification of FIG. 2A and FIG. 2B, analogous parts are designated by like reference numerals as in FIG. 1A.

In the embodiment modification as shown on FIG. 2A, the hydropneumatic cylinder according to the present invention is constructed with a double rod having a front end 18a axially extending in a sealing engagement through an axial bore formed in the front closure 9, and a rear end 18b axially extending in a sealing engagement through an axial bore formed in the rear closure 12, thereby allowing to translate the motion generated by the actuation means into motion which can be utilized externally.

Otherwise, the embodiments of FIG. 2A and FIG. 1A are completely analogous by construction and functionally.

In the embodiment modification as shown on FIG. 2B the cylinder, according to the present invention, is constructed with a hollow double rod having a front end 18a axially extending in a sealing engagement through an axial bore formed in the front closure 9, and a rear end 18b axially extending in a sealing engagement through an axial bore formed in the rear closure 12. Otherwise, the embodiments of FIG. 2B and FIG. 2A are analogous by construction and functionally.

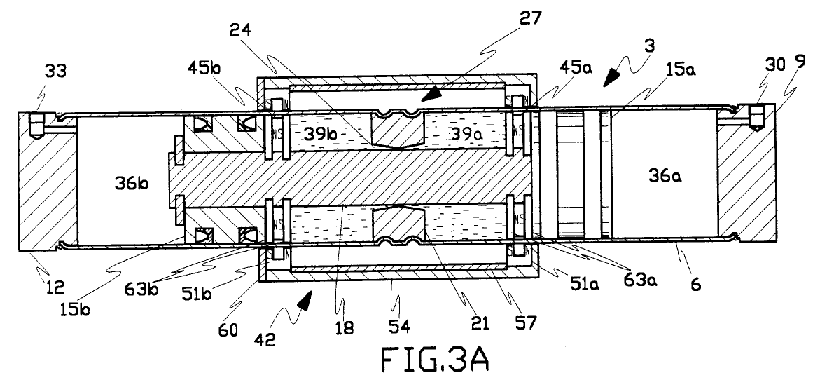

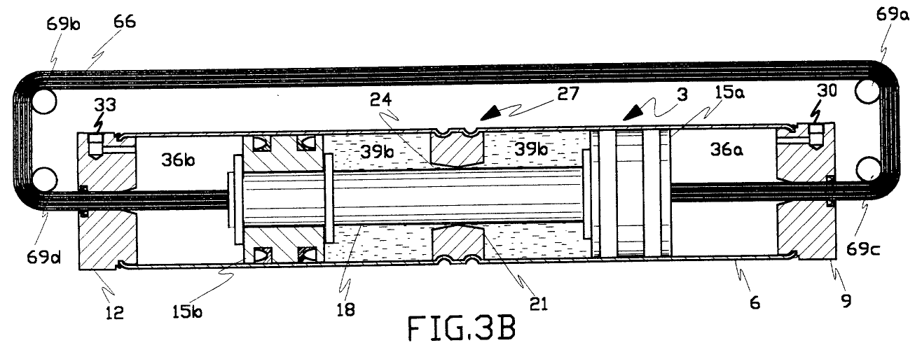

FIG. 3A shows a longitudinal sectional view of another embodiment of a hydropneumatic cylinder according the present invention.

The hydropneumatic cylinder shown in FIG. 3A comprises a housing unit 3, actuating means that further comprises two joined in tandem equal diameter pistons, a first piston 15a and a second piston 15b, with both pistons fixedly mounted on a constant diameter rod 18, a dividing member 21 installed stationary inside housing unit 3, a dampening fluid path 24, and a dampening fluid flow governor means 27. These components are functionally and structurally analogous to the similar components used in the first embodiment, however, hydropneumatic cylinder of this embodiment further comprises a carriage unit 42, having a set of two magnets, 51a and 52b, installed into a carriage housing 54 and secured with retainers 57 and 60.

The housing unit 3 of this embodiment is composed of a hollow cylindrical body 6, a front closure 9, fixedly mounted at the front end of the hollow cylindrical body 6, and a rear closure 12, fixedly mounted at the rear end of the hollow cylindrical body 6. The actuating means divide the active volume inside housing unit 3 into three chambers 36a (adjacent to the front closure 9) and 36b (adjacent to the rear closure 12), and a chamber in the middle of the housing unit 3, which is further composed of a chamber 39a and a chamber 39b formed by the dividing member 21 being positioned across the third chamber between pistons 15a and 15b.

The front closure 9 is formed with an air channel 30. The rear closure 12 is formed with an air channel 33. Through the air channels 30 and 33 compressed air can be provided into the chambers 36a and 36b to power the actuating means.

The rod 18 axially extends through an axial bore formed in the dividing member 21 and, in combination with the dividing member 21, forms the dampening fluid path 24 and the dampening fluid flow governor means 27. The dampening fluid path 24 is formed as an annular tube between the wall surface of the bore through the dividing member 21 and the surface of the rod 18. The dampening fluid flow governor means 27 is formed as a narrowed annular orifice between the wall surface of the bore through the dividing member 21 and the surface of the rod 18.

Due to the constant diameter of the rod 18 and the equal diameter of the pistons 15a and 15b the conditions of “zero volumetric differential” is achieved for the hydraulic cylinder of this embodiment.

Unlike in all the prior embodiments this embodiment utilizes magnetic coupling for translating the motion generated by the actuation means into motion of the carriage 42 which can be used externally. For this purpose the actuating means, in accordance with the embodiment shown FIG. 3A, also comprises: a magnet 45a, adjacent to the piston 15a, with two identical magnetic yokes 63a made of magnetically soft material, and a magnet 45b, adjacent to the piston 15b, also with two identical magnetic yokes 63b. The magnet 45a forms a magnetic bond with the magnet 51a of the carriage unit 42 and the magnet 45b forms a magnetic bond with the magnet 51b of the same carriage unit.

Cylinders of such construction are known as “rodless” cylinders.

When compressed air is let into the channel 30 and further to the chamber 36a it causes the piston 15a to move to the left. Respectively, when compressed air is let into the channel 33 and further to the chamber 36b it causes the piston 15b to move to the right. During such displacements of actuating means the dampening fluid contained in the chambers 39a and 39b of the hydraulic cylinder is being effectively redistributed between the hydraulic chambers 39a and 39b, whereby hydraulic dampening takes place. For example, when the actuating means move to the right the dampening fluid is forced from the hydraulic chamber 39b through the dampening fluid path 24 and the fluid flow governor means 27 into the hydraulic chamber 39a. The hydraulically dampened motion of the actuating means through the magnetic bonds between the magnets 45a and 51a, and also between magnets 45b and 51b is being translated into a usable smooth motion of the carriage unit 42.

Naturally, the instances described above should not be construed as limitations on the scope of this invention. Similar to the first embodiment case, the current embodiment can be arranged with different types and combinations of governor means.

FIG. 3B shows the longitudinal sectional view of a modification of a hydropneumatic cylinder, according the present invention, which is equipped with a flexible cable 66 to transfer the displacement generated by the tandem pistons 15a and 15b.

In the instance shown on FIG. 3B the trajectory of the flexible cable 66 is defined by four rollers 69a, 69b, 69c, and 69d. However, there are limitless possibilities for the types of rollers and their configurations.

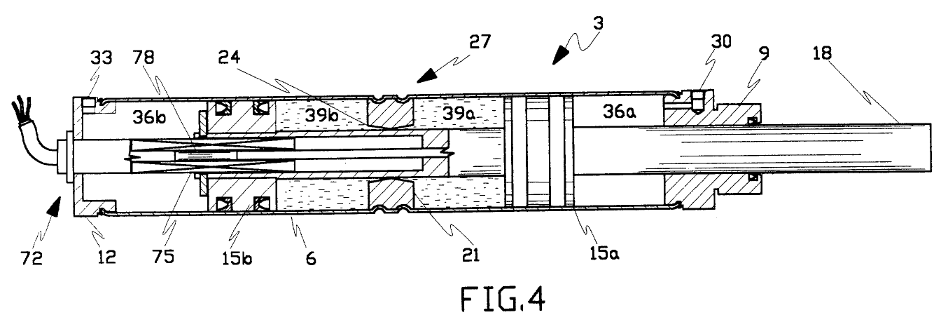

FIG. 4 shows the longitudinal sectional view of another embodiment modification of a hydropneumatic cylinder according the present invention. In the embodiment modification of FIG. 4 analogous parts are designated by like reference numerals as in FIGS. 1A, 1B and 1C. The embodiment of FIG. 4 is identical to the first embodiment of the present invention, but is additionally equipped with a linear displacement transducer 72.

In the instance presented on FIG. 4 the linear displacement transducer 72 is an inductive transducer comprised of an inductive coil 75 built into the rear closure 12, and a magnetically soft probe 78 installed into the rod 18.

At any position of the rod the linear displacement transducer 72 generates an electrical signal the voltage level of which corresponds to the current position of the rod.

The hydropneumatic cylinder according to the present invention can be also equipped with other types of transducers (linear displacement encoders and other type transducers for determining the position of the pneumatic cylinder actuation means and for forming positional feedback, speed transducers, acceleration transducers, load transducer, etc.) as well as multiple combinations of them.

Depending on the specifics, applications, and uses many other types of linear displacement transducers, fluid flow governor means and other elements and their combinations can be used with the hydropneumatic cylinders according to the present invention and it will be obvious to those skilled in the art.

What is claimed is:

1. A hydropneumatic cylinder comprising:
a. a hollow cylindrical housing unit for providing casing and structural core formed with at least two channels whereby pneumatic energy is provided to said pneumatic actuator actuation means,
b. at least one actuating means for generating pneumatically powered actuation and simultaneous hydraulic dampening slidably disposed inside said hollow cylindrical housing unit and further composed of equal diameter a first piston and a second piston joint in tandem by being fixedly mounted on a constant diameter rod,
c. a dividing member for forming hydraulic chambers fixedly installed inside said hollow cylindrical housing unit, said dividing member is formed with an axial bore and disposed between said first piston and said second piston with said constant diameter rod slidably extending through said axial bore, whereby a first hydraulic chamber is formed between said first piston and said dividing member, and a second hydraulic chamber is formed between said second piston and said dividing member, said first hydraulic chamber and said second hydraulic chamber are completely filled with dampening fluid and permanently sealed, whereby said hollow cylindrical housing unit, said actuating means and said dividing member compose a dampening positive-displacement hydraulic cylinder with zero volumetric differential,
d. at least one dampening fluid path for connecting said first hydraulic chamber and said second hydraulic chamber, said dampening fluid path is being completely filled with dampening fluid, and
d. at least one damping fluid flow governor means disposed in series with said damping fluid path for controlling flow rate of damping fluid transfer between said first hydraulic chamber and said second hydraulic chamber,
whereby pneumatically powered actuation of said actuation means will be provided with incompressible hydraulically controlled dampening and positioning.

2. The hydropneumatic actuator of claim 1 wherein said dampening fluid flow governor means is comprised of at least one permanent orifice.

3. The hydropneumatic actuator of claim 1 wherein said dampening fluid flow governor means is comprised of at least one valve.

4. The hydropneumatic actuator of claim 1 wherein said dampening fluid flow governor means is comprised of at least one permanent orifice and at least one valve.

5. The hydropneumatic actuator of claim 1 wherein said actuating means is formed with a single rod axially extendable through one end of said hollow cylindrical housing unit in sealing engagement for translating pneumatically generated displacement of said actuating means into externally usable motion.

6. The hydropneumatic actuator of claim 1 wherein said actuating means is formed with a double rod axially extendable through two opposite ends of said hollow cylindrical housing unit in sealing engagement for translating pneumatically generated displacement of said actuating means into externally usable motion.

7. The hydropneumatic actuator of claim 1 wherein said actuating means is formed with a hollow double rod axially extendable through two opposite ends of said hollow cylindrical housing unit in sealing engagement for translating pneumatically generated displacement of said actuating means into externally usable motion.

8. The hydropneumafic actuator of claim 1 wherein said hydropneumatic actuator is having a carriage unit axially sliding on said hollow cylindrical housing unit and comprising at least one fixedly attached permanent magnet, and said actuating means is having at least one fixedly attached permanent magnet magnetically coupled with said carriage unit permanent magnet for translating pneumatically generated displacement of said actuating means into externally usable motion.

9. The hydropneumatic actuator of claim 1 wherein each end of said actuating means is having an axially attached end of a flexible cable axially extendable through both ends of said hollow cylindrical housing unit in sealing engagement whereby forming a cable loop for translating pneumatically generated displacement of said actuating means into externally usable motion.

10. The hydropneumatic actuator of claim 1 wherein said hydropneumatic actuator is having a displacement transducer for translating position of said actuating means with respect to said hollow cylindrical housing unit into electrical signal.
